(19) United States
(12) Patent Application Publication
(10) Pub. No.: US 2016/0257844 A1
(43) Pub. Date: Sep. 8, 2016

(54) Laminate Having An Aminoplast Resin-Containing Coating

(71) Applicant: FRITZ EGGER GMBH & CO. OG, St. Johann in Tirol (AT)

(72) Inventors: Andreas Geyer, Krems (AT); Thomas Schalkhammer, Wiesmath (AT)

(21) Appl. No.: 14/900,968

(22) PCT Filed: Jun. 17, 2014
(86) PCT No.: PCT/EP2014/062650

§ 371 Date: Dec. 22, 2015

(30) Foreign Application Priority Data
Jun. 25, 2013 (DE) 102013010494.7

(51) Int. Cl. C09D 161/32

(52) U.S. Cl. CPC C09D 161/32

(57) ABSTRACT

A laminate is presented and described, which has at least one layer that comprises an aminoplastic resin, where the aminoplastic resin is a condensate obtainable via reaction of a reaction mixture which comprises (1) formaldehyde, (2) a component comprising amino, imino, or amide groups, and (3) at least one alkoxysilane, organoalkoxysilane, or metal alkoxide. Laminates of this type feature particularly high resistance to microscratching.

The invention relates to a laminate which has at least one layer that comprises an aminoplastic resin. The invention further relates to the use of an aminoplastic resin as impregnation resin or liquid overlay in the production of impregnated material or of a laminate, or for the surface-treatment of wood-derived materials. Finally the invention relates to a process for the production of this type of aminoplastic resin, and also to an aminoplastic resin obtainable via said process.

Aminoplastic resins are well known in the wood-processing industry in the form of impregnating resins and so-called as liquid overlay layers. They are described by way of example in “Ullmanns Enzyklopädie der technischen Chemie” [Ullmann's Encyclopedia of industrial chemistry], 4th edn., 1974, in the chapter entitled “Aminoplaste” [Aminoplastics] in volume 7.

The term laminate as used herein means a product which comprises at least two layers bonded to one another via their large surfaces. These layers can be composed of identical or different materials.

Laminates used as floor panels usually have a layer structure where the uppermost layer is mostly composed of an aminoplastic-resin-impregnated overlay paper or aminoplastic-resin-impregnated decorative paper. The uppermost layer can also be a separately applied layer of aminoplastic resin, for example in the form of what is known as a liquid overlay. Overlay paper and liquid overlay layers serve to protect the surface from exterior effects such as wear and scratching. A decorative paper is a printed or colored specialty paper that is used for the decorative coating of wood-derived materials.

The term aminoplastics is generally understood to mean polycondensates obtained via reaction of a carbonyl compound, which in industry is mostly formaldehyde, with a component comprising amino, imino, or amide groups. Aminoplastic resins that are most important commercially in this context are urea-formaldehyde resins and melamine-formaldehyde resins.

The aminoplastic resins used as impregnation resin or liquid overlay in the timber-processing industry are often aminoplastic precondensates comprising unetherified methylol groups or comprising methylol groups partially etherified with alcohols. They are generally produced in an aqueous medium, and also processed or marketed in aqueous form. Aminoplastic resins often serve as impregnation resins for the impregnation of paper webs, in particular of overlay papers or decorative papers, both of which are then used for the production of laminates or pressure laminates, decoratively coated particle boards, or compact laminates. To this end, the paper webs are impregnated with impregnating resins with which a hardener and/or other additives have optionally been admixed. The impregnated paper webs are then pressed onto wood-derived materials (for example MDF, HDF, or particle board), or are pressed with a stack of other resinified papers to give a pressure laminate or a compact laminate.

It is also possible to use aminoplastic resins directly for the surface-coating of wood-derived materials.

In a known method for increasing the resistance of laminate and of wood-derived materials to scratching and to abrasion, an additional transparent film known as overlay film is coated onto the decorative and/or overlay papers or onto the surface of the wood-derived material. The term liquid overlay is conventionally used in the sector for this type of applied material. Aminoplastic resins are likewise used in industry for this overlay film.

Laminates produced in this way, comprising at least one layer of aminoplastic resin (for example in the form of impregnating resin or in the form of an overlay film) are mainly used as floorcovering, for the fitting-out of interiors, or for the production of furniture.

Examples of properties that are in particular of decisive importance for the use of these laminates as floorcovering, but also for furniture production, are abrasion resistance, scratch resistance, and/or wear resistance.

The prior art describes various processes for increasing abrasion resistance, scratch resistance, and wear resistance of decorative pressure laminates, and in particular other laminates. In practice, fine particles of hard material, for example made of corundum (Al₂O₃), are admixed to the aminoplastic resin used for impregnation or for the liquid overlay.

EP 1 584 666 A1 describes by way of example the addition of particularly fine-particle fillers to aminoplastic resins with which papers are impregnated during the production of laminate. Laminates produced from papers of this type have improved scratch resistance, but it is nevertheless said to be possible to achieve a glossy surface.

Admixture of corundum or other fine-particle fillers to the aminoplastic resin generally leads to an increase in the abrasion resistance of the laminates, and reduces their tendency to form large deep scratches.

However, the processes known from the prior art are not capable of ensuring satisfactory improvement of resistance to scuffing or to microscratching. Resistance to scuffing or to microscratching is of ever-increasing importance because of the increased requirements placed in recent years on the design and esthetics of laminate floors. Increased resistance of floors to scuffing or to microscratching is in particular desirable in relation to gloss level. It avoids the very fine scratches on the surface which can arise during manufacture, transport, and installation, and typically also create an unfavorable impression in the form of signs of wear and of gloss-level changes on floor areas subject to heavy pedestrian traffic.

WO 2009/133144 A1 proposes, for improving resistance to microscratching, an aminoplastic resin which is used as impregnating resin or liquid overlay in the production of laminate, and comprises surface-modified SiO₂ nanoparticles (silica nanoparticles). This aminoplastic resin can be obtained firstly by producing a dispersion from ready-to-use dispersion of silica nanoparticles and ready-to-use aminoplastic resin. Alternatively, it is also possible that the ready-to-use silica nanoparticles are added before the synthesis of the aminoplastic resin is completed, or else are sprayed onto the paper that has already been impregnated with the aminoplastic resin. The average particle diameter of the silica nanoparticles used is preferably about 5 to 60 nm.

The requirement for ready-to-use nanoparticles is a disadvantage of the procedure described in WO 2009/133144 A1. These firstly require complicated production, drying, and measurement, or else have to be purchased. There is moreover also the perceived risk that nanoparticles could possibly be hazardous to health. Possible inhalation of nanoparticles during the manufacture of the modified aminoplastic resins by the operators could represent a health risk. At the very least, this risk is currently difficult to judge because of lack of available long-term studies.

Another disadvantage of the processes described above, known from the prior art, is that when ready-to-use particulate fillers are added it is often impossible to achieve uniform homogeneous distribution of the particles in the resin matrix and across the entire area of the impregnated paper. In practice it is also possible, depending on the compositions of the aminoplastic resin and certain types of nanoparticles used that poor compatibility may occur which can be discernible, inter alia, in a lack of full dispersibility.

On the basis of the prior art explained above, it was an object of the invention to provide a low-cost process which is intended for the production of a laminate and with which it is possible, in a simple and cost-effective manner, to increase the resistance of the surfaces to scuffing and/or to microscratching, without any need here to use unconstrained nanoparticles.

Another object of the invention was to provide an aminoplastic resin which, in comparison with the prior art, has improved resistance to exterior effects, in particular higher resistance to microscratching, while retaining the conventional quality features of aminoplastic resins of this type, for example maximum transparency, and/or maintaining the high gloss of the laminate after application of the aminoplastic resin.

The invention achieves these objects via the laminate provided in claim 1, the uses provided in claims 17 and 18, the process provided in claim 20, and the aminoplastic resin described in claim 22.

Advantageous embodiments of the invention are provided in the dependent claims, and are explained in detail hereinafter, as also is the general concept of the invention.

The laminate of the invention has at least one layer that comprises/consists of the aminoplastic resin of the invention. The aminoplastic resin of the invention is a condensate obtainable via reaction of a reaction mixture which comprises (1) formaldehyde, (2) a component comprising amino, imino, or amide groups, and (3) at least one alkoxysilane, organoalkoxysilane, or metal alkoxide.

The formaldehyde and components comprising amino, imino, or amide groups here are the conventional starting materials for the production of an aminoplastic resin. Surprisingly, it has been found that it is possible to introduce alkoxysilanes, organoalkoxysilanes, or metal oxides, where these represent conventional nanoparticle-precursor substances, directly into the reaction mixture for the production of an aminoplastic resin, and to bring about reaction of these. Without any intention of adopting a scientific theory, it is likely that co-condensation of the nanoparticle-precursor substances with the developing aminoplastic matrix occurs here, and that at least to some extent in situ formation of nanoparticles or of other structures occurs in the reaction mixture.

In practical tests, laminates which have at least one layer that comprises this aminoplastic resin of the invention exhibited increased resistance to microscratching and to scuffing. This resistance was determined by means of a modified Martindale test, a standardized test method for determining resistance of laminate floors to microscratching (DIN EN ISO 12947: 04/1999 or IHD W-445, version of May 2007).

The increased resistance to microscratching is believed to be attributable to the fact that the at least one alkoxysilane, organoalkoxysilane, or metal alkoxide form finely distributed, nanoscale structures which have been covalently crosslinked with the aminoplastic resin matrix and, thus, increase the hardness thereof. A particularly homogeneous distribution of the inorganic constituents in the aminoplastic resin matrix is obtained because, in the invention, the nanoparticle-precursor substances are added directly to the aminoplastic resin condensation mixture, and are reacted together with the same. By virtue of the high degree of covalent crosslinking the aminoplastic resins of the invention further exhibit improved compatibility of the inorganic component with the aminoplastic resin matrix when comparison is made with the use, known from the prior art, of ready-to-use silica nanoparticles as materials for addition to aminoplastic resins.

When the term laminate is used in this specification, it means a product which comprises at least two layers bonded to one another via their large surfaces. These layers can be composed of identical or different materials. At least one of said two layers comprises the aminoplastic resin of the invention. It is preferred that at least one layer of the laminate of the invention comprises wood, lignocellulose, paper, nonwoven, fiber materials, textile, or knitted fabric, or a combination thereof.

The at least two layers are bonded via pressing under elevated pressure and at elevated temperature. The aminoplastic resin here becomes liquid for a short time and then reacts by polycondensation to give the finished laminate with durable bonding to the other layer.

In one embodiment of the invention the laminate comprises at least two layers, where the first layer comprises lignocellulose, wood, and/or a wood-derived material, and the second layer comprises, or consists of, the aminoplastic resin of the invention. The second layer can also take the form of impregnated material, i.e. can also comprise the aminoplastic resin of the invention in the form of a paper, nonwoven, fiber material, textile, or knitted fabric impregnated therewith.

Before the press process, the directly applied layer of aminoplastic resin or the impregnated material is dried to a certain residual moisture level, preferably to from 2 to 8%, particularly preferably to from 4 to 6%.

In another embodiment of the invention the laminate is a pressure laminate which comprises a plurality of aminoplastic-resin-impregnated paper layers combined under high pressure. A pressure laminate of thickness 2 mm or more is known as a compact laminate. In the invention at least one paper layer of the pressure laminate or of the compact laminate, preferably the final or penultimate paper layer, has been saturated with the aminoplastic resin of the invention. Alternatively, or in addition, the pressure laminate can also have a separately applied external layer (known as overlay layer or finished layer) which comprises the aminoplastic resin of the invention. Among pressure laminates for the purposes of this invention are not only compact laminates but in particular also HPL (“High Pressure Laminate”) and CPL (“Continuous Pressure Laminate”).

Pressure laminates, in particular compact laminates, which comprise the aminoplastic resin of the invention have particularly good suitability for facade cladding. It appears that the aminoplastic resin of the invention has a favorable effect on the weathering resistance of the compact laminates. In one embodiment a metal oxide is added to the aminoplastic resin of the invention. If an aminoplastic resin of this type is used in the production of a compact laminate, this exhibits increased UV absorption when comparison is made with the compact laminates usually used in the prior art.

In another embodiment the laminates which comprise the aminoplastic resin of the invention are antibacterial. It is preferable that for this purpose a metal oxide is added to the aminoplastic resin of the invention or that the aminoplastic resin of the invention comprises a metal oxide, in particular MoO₃ or WoO₃. The resultant antibacterial effect is believed to be explained by formation of H+ ions in the presence of an aqueous medium, thus rendering the pH of the aqueous medium acidic, so that the aqueous medium becomes antimicrobial.

Other typical laminates for the purposes of this invention are moreover boards which comprise wood-derived material, where these have been coated with a layer of aminoplastic resin of the invention; boards which comprise wood-derived material, where these have been coated with a decorative paper saturated with the aminoplastic resin of the invention, and pressure laminates or compact laminates, where these comprise papers resinified with the aminoplastic resin of the invention.

Impregnated materials are also laminates for the purposes of this invention. Impregnated materials have at least one layer which comprises paper, nonwoven, fiber material, textile, or knitted fabric and which has been impregnated and/or coated with the aminoplastic resin of the invention before being heated in a press to give the finished laminate.

The nanoparticle-precursor substances which are reacted in a reaction mixture with formaldehyde and the component comprising amino, imino, or amide groups to produce the aminoplastic resin of the invention are selected from the group consisting of alkoxysilanes, organoalkoxysilanes, and metal alkoxides. Compounds of this type are known to the person skilled in the art as precursor substances (precursors) for obtaining nanoparticles by means of what is known as the sol-gel process. A summary of the sol-gel process with a list of suitable precursors and other references is found by way of example in the overview article by Prof. H. K. Schmidt in “Chemie in unserer Zeit” [Chemistry in our time], 2001, vol. No. 3, pp. 176 to 184.

In one preferred embodiment a compound of the formula Si(OR)₄ is used as alkoxysilane, a compound of the formula R′ₓSi(OR)₄₋ₓ is used as organoalkoxysilane, and/or a compound of the formula Me(OR)₄ is used as metal alkoxide.

Each R here is optionally substituted alkyl or aryl, and with particular preference methyl, ethyl, butyl, or propyl;

each R′ here is halogen, in particular chlorine; optionally substituted alkyl, in particular methyl, ethyl, butyl, or propyl; or optionally substituted aryl;

x is a number from 1 to 4; and

Me is a metal, semimetal or transition metal, with particular preference it is Al, Ti, or Zr.

It is preferable that the aminoplastic resin of the invention uses organically modified silanes, i.e. alkoxysilanes and/or organoalkoxysilanes.

An alkoxysilane or organoalkoxysilane that has been found to be particularly suitable for many intended applications is one selected from the group consisting of tetramethoxysilane, tetraethoxysilane, tetrapropoxysilane, methyl glycol orthosilicate, ethyl glycol orthosilicate, methyltrimethoxysilane, methyltriethoxysilane, dimethyldimethoxysilane, dimethyldiethoxysilane, ethyltrimethoxysilane, ethyltriethoxysilane, trimethylethoxysilane, 2-chloroethyltriethoxysilane, vinyltrimethoxysilane, vinyltriethoxysilane, vinylmethyldiethoxysilane, vinyltris(2-methyloxyethoxy)silane, phenyltrimethoxysilane, 2-phenylethyltri-methoxysilane, diphenyldimethoxysilane, propyltrimethoxysilane, propyltriethoxysilane, 3-chloropropyltrimethoxysilane, 3-chloropropyltriethoxysilane, propylmethyldimethoxysilane, propylmethyldiethoxysilane, 3-chloropropylmethyldimethoxysilane, 3-chloropropylmethyldiethoxysilane, isobutyltrimethoxysilane, isobutyltriethoxysilane, amyltrimethoxysilane, amyltriethoxysilane, octyltrimethoxysilane, octyltriethoxysilane, cyclohexyltrimethoxysilane, cyclohexylmethyldimethoxysilane, hexadecyltrimethoxysilane, and hexadecyltriethoxysilane, and combinations thereof.

Ideal results are obtained when tetramethoxysilane, tetraethoxysilane, and/or tetrapropoxysilane was used as alkoxysilane.

The teaching of the invention can also be realized in another embodiment of the invention in that the alkoxysilane/organoalkoxysilane has been functionalized with reactive groups suitable for crosslinking with the aminoplastic matrix.

These reactive groups are preferably selected from epoxy, methacrylic, glycidoxy, glycidoxypropyl, amine, hydroxy, carboxy, and vinyl, and mixtures thereof.

Practical tests have shown that particularly good results in respect of resistance to microscratching can be achieved when the reaction mixture comprises, as co-solvent for the alkoxysilane, organoalkoxysilane, or metal alkoxide, an organic solvent, in particular glycerol, glycols, glycol ether (the products known as Dowanols and available as such), ethanol, or DMSO, or a mixture thereof.

The hydrolysis and condensation of the nanoparticle-precursor substances, i.e. the alkoxysilane, organoalkoxysilane, or metal alkoxide, is carried out in the invention during the aminoplastic-condensation reaction, i.e. in situ. The water required for the hydrolysis is either already present in the reaction mixture or can be added. Water and/or an alcohol produced during the hydrolysis and condensation can in turn by way of example be removed by means of vacuum during or after the reaction.

The procedure in the invention differs from that for the aminoplastic resins known from the prior art that comprise nanoparticles in that it does not begin by, for example, using a sol-gel process to produce nanoparticles, which are dried in order then to be introduced into an aminoplastic resin. Instead, the invention carries out a type of sol-gel process simulta-neously with the aminoplastic-condensation reaction, i.e. in situ, thus providing access to a novel aminoplastic resin comprising inorganic nanostructures.

A particular advantage of the process of the invention, when comparison is made with the prior art, is that there is no longer any need to introduce powder comprising nanoparticles into the ready-to-use aminoplastic resin, and it is therefore possible to omit a dispersion process.

The component comprising amino, imino, or amide groups can in principle be selected from the compounds of this type already known from aminoplastic production. In one particular embodiment of the invention the component comprising amino, imino, or amide groups is selected from urea, melamine, thiourea, cyanamide, dicyandiamide, and diaminohexane, and mixtures thereof. Ideal results are obtained when urea and/or melamine is used as component comprising amino, imino, or amide groups.

The aminoplastic resin of the invention can also comprise, alongside the abovementioned components, other additives, for example wetting agents, hardeners, or release agents, etc. In one embodiment the aminoplastic resin can also have been completely or to some extent etherified by alcohols, in particular C₁ to C₄ alcohols such as methanol, glycol, and/or butanol.

In respect of the composition of the reaction mixture it has been found to be particularly useful that the reaction mixture comprises, based on the total weight thereof, a quantity of from 10 to 20% by weight, with preference from 12 to 16% by weight, of formaldehyde, a quantity of from 25 to 45% by weight, with preference from 30 to 40% by weight, of the component comprising amino, imino, or amide groups, and a quantity of from 2 to 25% by weight, with preference from 5 to 15% by weight, of the alkoxysilane, organoalkoxysilane, or metal alkoxide.

In the process of the invention for the production of the aminoplastic resin it is in principle possible to add the alkoxysilane, organoalkoxysilane, or metal alkoxide at any stage of the aminoplastic-condensation reaction. The alkoxysilane, organoalkoxysilane, or metal alkoxide can also in particular be added to the original reaction mixture before the aminoplastic-condensation reaction begins.

However, practical tests have shown that it is advantageous to react the reaction components with one another in succession. This is best achieved in that the formaldehyde and the component comprising amino, imino, or amide groups are first precondensed to a certain degree with one another, and only then are reacted with the alkoxysilane, organoalkoxysilane, or metal alkoxide.

By way of example it is possible to begin by—as is conventional in the production process known in the prior art for production of aminoplastic impregnation resin—reacting formaldehyde and the component comprising amino, imino, or amide groups, and optionally other additives, in particular solubilizers such as alcohols, sugars, glycols, and derivatives thereof, propylene glycol (PPG), glycerol, or dimethyl sulfoxide (DMSO), with one another at elevated temperatures until the solution becomes clear, before the at least one alkoxysilane, organoalkoxysilane, or metal alkoxide is added and the reaction of the reaction mixture is continued.

In one particular embodiment of the invention before the at least one alkoxysilane, organoalkoxysilane, or metal alkoxide is added to the reaction mixture the formaldehyde component and the component comprising amino, imino, or amide groups present in the reaction mixture have been precondensed to a level of at least 20%, preferably at least 50%.

The degree of precondensation can be determined by cloud point measurements as follows. During the course of condensation of the aminoplastic resin the increasing molecular weight causes a continuous decrease in water-dilutability, which is infinite at the start of the condensation reaction. This situation is utilized by using water-compatibility measurements or cloud point measurements for indirect determination of the degree of condensation of the resin.

Cloud point [CP(1+6)] is measured by adding, to a defined sample quantity of aminoplastic resin, 6 times the volume of warm distilled water (60° C.). The mixture is then slowly cooled. The point of onset of clouding of the sample mixture is recorded as cloud point of the relevant sample.

Cloud points of condensed aminoplastic resins at the end of the condensation phase are usually from about 40 to about 60° C.

In one preferred embodiment before the at least one alkoxysilane, organoalkoxysilane, or metal alkoxide is added to the reaction mixture the formaldehyde component and the component comprising amino, imino, or amide groups present in the reaction mixture are already precondensed as far as a cloud point [CP(1+6)] of from 20 to 50° C.

In another preferred embodiment the precondensation reaction takes place at a higher temperature than the subsequent reaction with the alkoxysilane, organoalkoxysilane, or metal alkoxide. Ideal results are obtained when the precondensation reaction is carried out at about 120 to 80° C. and the subsequent reaction with the alkoxysilane, organoalkoxysilane, or metal alkoxide is carried out at about 50 to 80° C.

After addition of the at least one alkoxysilane, organoalkoxysilane, or metal alkoxide it is preferable that the reaction of the reaction mixture is continued until at least 50 mol % of the at least one alkoxysilane, organoalkoxysilane, or metal alkoxide has been hydrolyzed and/or condensed in the presence of formaldehyde and of the component comprising amino, imino, or amide groups. The reaction here can be monitored for example via the decrease in pH of the reaction mixture, which proceeds in parallel therewith.

The decrease in pH can amount to up to 1 pH unit, in particular in the case of high contents of alkoxysilane, organoalkoxysilane, or metal alkoxide. In this condensation phase of the formulation, the aminoplastic resin no longer causes any particular change of pH, and pH changes can therefore be regarded as direct indication of the reaction of the alkoxysilane, organoalkoxysilane, or metal alkoxide. A decrease in pH of as little as from 0.2 to 0.6 pH units is therefore typically an indication of significant reaction of the precursors mentioned.

Practical tests have shown that the pH of the reaction mixture is an important factor in the production of the aminoplastic resin of the invention. In one preferred embodiment of the invention the reaction of the reaction mixture takes place at a pH of at least 8.0, preferably at least 9.0, and with particular preference at a pH of from 9.0 to 11.0. Compliance with these pHs during the reaction of the reaction mixture which comprises formaldehyde, a component comprising amino, imino, or amide groups, and at least one alkoxysilane, organoalkoxysilane, or metal alkoxide can produce aminoplastic resins with particularly good properties in respect of resistance to microscratching.

The temperature to be set during the reaction of the reaction mixture depends on the components used. In principle it is possible to achieve satisfactory results when the reaction of the reaction mixture takes place in the temperature range from 20° C. to 90° C., preferably from 40° C. to 85° C., and particularly preferably from 60° C. to 80° C.

The aminoplastic resin thus obtainable is used in the invention for the surface-treatment of wood-derived materials, or as impregnation resin and/or liquid overlay in the production of laminate.

Accordingly, the invention also provides a laminate which has at least one layer that comprises, or consists of, the aminoplastic resin of the invention.

This layer can have been applied separately, e.g. as liquid overlay. However, this can also be a paper impregnated with the aminoplastic resin. If the wood-derived material has a paper layer, for example in particular a decorative paper or overlay paper, the layer of aminoplastic resin can have been applied to this paper layer and/or can be present therein. If the layer of the aminoplastic resin of the invention is applied separately, e.g. as liquid overlay, this surface coating can by way of example be achieved via rolling, spraying, or doctoring, and also optionally by spreading.

The thickness of the finished aminoplastic resin layer (after pressing) is preferably from 0.5 to 100 μm, with preference from 10 to 100 μm, with particular preference from 20 to 40 μm.

The layer comprising aminoplastic resin is responsible for the increased resistance of the wood-derived material of the invention to microscratching, and therefore particularly good results are achieved in this connection when the arrangement has this layer as close as possible to the surface of the wood-derived material. In a preferred embodiment of the invention the layer comprising the aminoplastic resin forms a surface of the wood-derived material, i.e. it is located at a surface of the wood-derived material.

The wood-derived materials provided with the aminoplastic resin of the invention feature particularly high resistance to microscratching. In another embodiment of the invention the wood-derived materials of the invention exhibit an improvement of resistance to microscratching in the Martindale test (DIN EN ISO 12947:04/1999 or IHD W-445, version of May 2007), preferably an improvement to the extent of at least one class.

The expression “wood-derived material” in the invention means any desired, in particular board-shaped, materials which comprise lignocellulose, preferably wood, or particles, fibers, or strands made of wood. Examples of wood-derived materials for the purposes of the invention are boards derived from timber and moldings derived from timber, where these can be other composite materials made of individual wood-derived particles or else materials made of solid wood. Wood-derived materials for the purposes of this invention are in particular solid-wood-based materials, veneer materials, particulate materials, fiber materials, or other composite materials.

It is preferable in the invention that the wood-derived material comprises MDF, HDF, OSB, particle board, or solid-wood board, or consists thereof.

In one particularly preferred embodiment the laminate of the invention comprises a wood-derived material. In one variant this type of laminate has at least two mutually superposed layers, where at least one thereof comprises paper and/or lignocellulose, preferably wood, or particles, fibers, or strands made of wood. The lower and/or backing layer is preferably a board of wood-derived material, e.g. MDF, HDF, particle board, OSB, or else a solid-wood board. In one embodiment the upper layer can be a layer of the aminoplastic resin of the invention. The upper layer can by way of example be a decorative paper or an overlay paper. These papers are known to the person skilled in the art from the production of laminate. They are in particular designed in such a way that they can give good results in impregnation with an aminoplastic resin. In the laminate of the invention the layer of aminoplastic resin of the invention can either be produced via saturation of the paper forming the upper layer of the laminate or can be applied separately onto or underneath the upper layer of the laminate. The aminoplastic resin of the invention can itself also form the upper layer of the laminate. This equally permits the production of a thin overlay paper that is particularly resistant to microscratching, with the aid of the aminoplastic resin of the invention.

The increased resistance of the wood-derived materials of the invention to microscratching makes them particularly suitable for use as floorcovering, worktop, or table top, or for furniture production.

A working example will be used below to explain the principle of the invention in more detail.

### INVENTIVE EXAMPLE 1

300 g of formalin, 115 g of water, and 20 g of glycol were used as initial charge in a 1000 ml round-bottomed flask, and the reaction mixture was heated to 45° C. After adjustment of the mixture to pH 9.4, 285 g of melamine were added, and the mixture was heated to 100° C. The reaction mixture was first reacted only until the mixture became clear. The condensation reaction was retarded by cooling to 60° C., and after adjustment of the mixture to pH 10.0 110 g of tetraethoxysilane (TEOS) were added. The reaction mixture thus obtained was kept at 60° C. until the TEOS had reacted. The water produced during the reaction, and the alcohol, were then removed by means of vacuum (60° C., 150 mbar). The pH was adjusted to 9.5, and the aminoplastic resin was cooled to 28° C. This gave a clear and stable solution of aminoplastic resin.

### INVENTIVE EXAMPLE 2

A decorative paper (80 g/m²; Technocell) was impregnated with the aminoplastic resin from inventive example 1 in such a way as to achieve, after drying to a residual moisture level of 5.5%, a total resin application of 110% (atro=“absolutely dry”; this corresponds to the condition of the impregnated material after drying at 160° C. for a period of 5 minutes), based on the weight of the untreated decorative paper. The paper here was impregnated to an extent of 84% with the aminoplastic resin in a first impregnation trough and, after a first intermediate drying procedure in a so-called screen unit, provided with the other 26% of the resin solution, each value again being based on the untreated decorative paper, in the form of resin coating on both sides in what is known as a screen unit. The following were added here to the aminoplastic resin liquor shortly before the impregnation of the decorative paper: 0.4% of wetting agent (Kauropal; BASF), 0.35% of hardener (MH 836; BASF), and 14% of water.

The impregnated decorative paper was dried to a residual moisture level of 5.5%. The impregnated decorative paper was then pressed together with three layers of a phenolic-resin-impregnated kraft paper, and also with a balancing material, using a pressure of 400 N/cm² at 175° C. for two minutes, and was then cooled back to 80° C.

### INVENTIVE EXAMPLE 3

A decorative paper (80 g/m²; Technocell) was impregnated with the aminoplastic resin from inventive example 1 in such a way as to achieve a total resin application of 90% (atro), based on the weight of the untreated decorative paper. The paper here was impregnated to an extent of 68% with the aminoplastic resin in a first impregnation trough and, after a first intermediate drying procedure, provided with the other 22% of the resin solution in the form of resin coating on both sides in what is known as a screen unit. The following were added here to the aminoplastic resin liquor shortly before the impregnation of the decorative paper: 0.4% of wetting agent (Kauropal; BASF), 0.35% of hardener (MH 836; BASF), and 14% of water.

The impregnated decorative paper was dried to a residual moisture level of 5.5%. The impregnated decorative paper and a balancing paper were then pressed with a particle board of thickness 18 mm, using a pressure of 350 N/cm² and a temperature of 175° C. for thirty seconds.

### INVENTIVE EXAMPLE 4

A decorative paper (65 g/m²; Technocell) was impregnated with a standard melamine-formaldehyde resin. The impregnated decorative paper was dried to a residual moisture level of 5.5%, its resin content (atro) then being 120%, based on the untreated decorative paper.

The dried impregnated paper was sprayed with the aminoplastic resin from inventive example 1. The application achieved here was 40 g/m².

The decorative paper was then again dried to a residual moisture level of 5.5%, and pressed by analogy with inventive example 2.

### INVENTIVE EXAMPLE 5

An overlay paper (22 g/m²; Technocell) was impregnated to an extent of 336% with a standard aminoplastic impregnating resin in the first impregnation trough and, after a first intermediate drying procedure, was provided with the aminoplastic resin described in inventive example 1 to an extent of 84% of the resin solution as resin coating on both sides in what is known as a screen unit, thus achieving in total a resin application of 420% (atro), based on the weight of the untreated decorative paper. Immediately after the application of the aminoplastic resin of the invention in the screen unit, before the second tunnel dryer, 15 g/m² of corundum of average grain size 50 microns were scattered by way of a scatter bar onto the surface of the impregnated overlay.

The following were added here to the aminoplastic resin liquor of the invention shortly before the impregnation of the decorative paper: 0.35% of wetting agent (Kauropal; BASF), 0.3% of hardener (MH 836; BASF), and 12% of water.

The impregnated overlay paper was dried to a residual moisture level of 5.5%. The impregnated overlay paper was then pressed together with an impregnated standard decorative paper (see inventive example 1) onto a 7.6 mm HDF board, the underside of which was provided with an impregnated balancing material, using a pressure of 350 N/cm² and a pressed temperature of 195° C. for 35 seconds.

### INVENTIVE EXAMPLE 6

An aminoplastic resin was produced as follows by a solvent-free method as alternative to inventive example 1.37.1 parts by volume of melamine resin, 1.4 parts by volume of dH₂O, and 2.8 parts by volume of TEOS (tetraethyl orthosilicate) were mixed, and 0.1 part by volume of 5 M NaOH (or optionally somewhat more) was added to increase the pH. The base is required here (see above) for the titration of the acidic SiO₂ groups produced by hydrolysis in the course of the reaction

The mixture is reacted in the reactor at 70° C. with efficient stirring within 2 hours. The mixture initially has 2 phases and is therefore cloudy. After somewhat less than 2 hours, the reaction solution becomes completely clear, indicating completion of the reaction, and giving a clear, colorless, and completely transparent aminoplastic resin.

The properties of the resultant aminoplastic resin in relation to improvement of resistance to microscratching were good and similar to those of the aminoplastic resin produced in inventive example 1 (cf. the determination of resistance to microscratching below and table 1).

### COMPARATIVE EXAMPLE 1

A decorative paper (80 g/m²; Technocell) was impregnated with a standard melamine-formaldehyde resin in such a way as to achieve a resin application of 110% (atro), based on the untreated decorative paper. The impregnated decorative paper was dried to a residual moisture level of 5.5%.

The decorative paper was then pressed by analogy with inventive example 2.

### COMPARATIVE EXAMPLE 2

A decorative paper (80 g/m²; Technocell) was impregnated with a standard melamine-formaldehyde resin in such a way as to achieve a resin application of 110% (atro), based on the untreated decorative paper. The impregnated decorative paper was dried to a residual moisture level of 5.5%.

The dried impregnated paper was sprayed with a standard melamine-formaldehyde resin which comprised a quantity of 5% by weight of commercially available aluminum oxide nanoparticles. The application achieved here was 20 g/m² (atro).

The decorative paper was then pressed by analogy with inventive example 2.

### Determination of Resistance to Microscratching

The resistance of the resultant laminates of inventive examples 2 to 5 and of comparative examples 1 and 2 to microscratching was tested by the Martindale test of DIN EN ISO 12947:04/1999 or IHD W-445, version of May 2007. In the typical procedure for this, samples measuring 15×15 cm are cut from the sample sheets. These are clamped into the Martindale apparatus (frame A). A “ScotchBrite” scourer pad (SB 7447; fine; red), weighted with a 6N weight, is placed on the surface to be tested, and the apparatus is started for 5 LB (Lissajous figures). The apparatus oscillates in x, y direction in such a way that the scourer pad produces microscratches in the form of what are known as Lissajous figures on the sample surface.

The surface was then evaluated visually, and the change of gloss level was determined.

Table 1 below collates the results of determination of gloss level change and thus of resistance to microscratching for the various laminates.

TABLE 1
Determination of change in gloss level for the various laminates.

| | | | Classifi- |
|---|---|---|---|
| Laminate | Paper | Impregnation/application | cation |
| Inv. Ex. 2 | Decorative paper, | 84% and 26% as in inv. | 1 |
| | 80 g/m² | ex. 1 | |
| Inv. Ex. 3 | Decorative paper, | 68% and 22% as in inv. | 2 |
| | 80 g/m² | ex. 1 | |
| Inv. Ex. 4 | Decorative paper, | 120% standard and 40 | 1 |
| | 65 g/m² | g/m² as in inv. ex. 1 | |
| Inv. Ex. 5 | Overlay paper, | 336% standard and 84% | 1 |
| | 22 g/m² | as in inv. ex. 1 | |
| Comp. Ex. 1 | Decorative paper, | 110% standard | 4 |
| | 80 g/m² | | |
| Comp. Ex. 2 | Decorative paper, | 110% standard, 20 g/m², | 2 |
| | 80 g/m² | 5% by wt. of nanoparticle | |

The meaning of the classification 1 to 5 here is:
1: No visible change of surface
2: Fine scratches just visible
3: Fine scratches visible
4: Deep scratches visible
5: Very deep scratches visible

The invention has been described above by way of example, with reference to working examples. This does not, of course, mean that the invention is restricted to the working examples described. Instead, there is a wide variety of possible variants and modifications available to the person skilled in the art within the scope of the invention, and the scope of protection of the invention is in particular defined via the claims below.

1. A laminate which has at least one layer that comprises an aminoplastic resin, wherein the aminoplastic resin is a condensate obtained via reaction of a reaction mixture at a pH of at least 8.0 wherein the reaction mixture comprises, based on its total weight,
(1) from 10 to 20% by weight of formaldehyde,
(2) from 25 to 45% by weight of a component comprising amino, imino, or amide groups, and
(3) from 2 to 25% by weight of at least one alkoxysilane, organoalkoxysilane, or metal alkoxide.

2. The laminate as claimed in claim 1, wherein the alkoxysilane is a compound of the formula Si(OR)₄, the organoalkoxysilane is a compound of the formula R′—Si(OR)₄₋ₓ, and the metal alkoxide is a compound of the formula Me(OR)₄, where
each R is optionally substituted alkyl or aryl, and with particular preference methyl, ethyl, butyl, or propyl;
each R′ is halogen, in particular chlorine; optionally substituted alkyl, in particular methyl, ethyl, butyl, or propyl; or optionally substituted aryl;
x is a number from 1 to 4; and
Me is a transition metal or other metal, or semimetal, with particular preference Al, Ti, or Zr.

3. The laminate as claimed in claim 1, wherein the alkoxysilane or organoalkoxysilane is selected from the group consisting of tetramethoxysilane, tetraethoxysilane, tetrapropoxysilane, methyl glycol orthosilicate, ethyl glycol orthosilicate, methyltrimethoxysilane, methyltriethoxysilane, dimethyldimethoxysilane, dimethyldiethoxysilane, ethyltrimethoxysilane, ethyltriethoxysilane, trimethylethoxysilane, 2-chloroethyltriethoxysilane, vinyltrimethoxysilane, vinyltriethoxysilane, vinylmethyldiethoxysilane, vinyltris(2-methyloxyethoxy)silane, phenyltrimethoxysilane, 2-phenylethyltrimethoxysilane, diphenyldimethoxysilane, propyltrimethoxysilane, propyltriethoxysilane, 3-chloropropyltrimethoxysilane, 3-chloropropyltriethoxysilane, propylmethyldimethoxysilane, propylmethyldiethoxysilane, 3-chloropropylmethyldimethoxysilane, 3-chloropropylmethyldiethoxysilane, isobutyltrimethoxysilane, isobutyltriethoxysilane, amyltrimethoxysilane, amyltriethoxysilane, octyltrimethoxysilane, octyltriethoxysilane, cyclohexyltrimethoxysilane, cyclohexylmethyldimethoxysilane, hexadecyltrimethoxysilane, and hexadecyltriethoxysilane, and combinations thereof.

4. The laminate as claimed in claim 1, wherein the alkoxysilane/organoalkoxysilane has been functionalized with reactive groups suitable for crosslinking with the aminoplastic resin.

5. The laminate as claimed in claim 4, wherein the reactive groups are selected from epoxy, methacrylic, glycidoxy, glycidoxypropyl, amine, hydroxy, carboxy, and vinyl, and mixtures thereof.

6. The laminate as claimed in claim 1, wherein the reaction mixture comprises, as cosolvent for the alkoxysilane, organoalkoxysilane, or metal alkoxide, an organic solvent, in particular Dowanol, ethanol, or DMSO.

7. The laminate as claimed in claim 1, wherein the reaction mixture comprises, based on the total weight thereof, a quantity of from 12 to 16% by weight of formaldehyde, from 30 to 40% by weight of the component comprising amino, imino, or amide groups, and a quantity of from 5 to 15% by weight of the alkoxysilane, organoalkoxysilane, or metal alkoxide.

8. The laminate as claimed in claim 1, wherein the formaldehyde component and the component comprising amino, imino, or amide groups, both, present in the reaction mixture have been precondensed to a level of at least 20%, in particular at least 50%, before the at least one alkoxysilane, organoalkoxysilane, or metal alkoxide is added to the reaction mixture.

9. The laminate as claimed in claim 1, wherein on reaction of the reaction mixture at least 50 mol % of the at least one alkoxysilane, organoalkoxysilane, or metal alkoxide are condensed and/or hydrolyzed in the presence of formaldehyde and of the component comprising amino, imino, or amide groups.

10. The laminate as claimed in claim 1, wherein the reaction of the reaction mixture takes place at a pH of at least 9.0, and with particular preference at a pH of from 9.0 to 11.0.

11. The laminate as claimed in claim 1, wherein the reaction of the reaction mixture takes place in the temperature range from 20° C. to 90° C., preferably from 40° C. to 85° C., and particularly preferably from 60° C. to 80° C.

12. The laminate as claimed in claim 1, wherein the component comprising amino, imino, or amide groups is selected from urea, melamine, thiourea, cyanamide, dicyandiamide, and diaminohexane, and mixtures thereof.

13. The laminate as claimed in claim 1, wherein the layer comprising aminoplastic resin is a material coated and/or impregnated with the aminoplastic resin, in particular a paper, nonwoven, fiber material, textile, or knitted fabric.

14. The laminate as claimed in claim 1, wherein the layer comprising aminoplastic resin forms a surface of the laminate.

15. The laminate as claimed in claim 1, wherein the resistance of the laminate to microscratching in the Martindale test (DIN EN ISO 12947:04/1999 or IHD W-445, version of May 2007) is in class 1 to 2.

16. The laminate as claimed in claim 1, wherein the laminate is selected from an impregnated material, a pressure laminate, a compact laminate, and a laminate which comprises a wood-derived material, MDF, HDF, OSB, particle board, or solid-wood board.

17. The use of a laminate as claimed in claim 1 as floorcovering, worktop, or table top, or for furniture production.

18. The use of an aminoplastic resin which is a condensate obtained via reaction of a reaction mixture at a pH of at least 8.0, wherein the reaction mixture comprises formaldehyde, a component comprising amino, imino, or amide groups, and at least one alkoxysilane, organoalkoxysilane, or metal alkoxide as impregnation resin or liquid overlay in the production of impregnated material or of laminate, or for the surface-treatment of wood-derived materials.

19. The use as claimed in claim 18, wherein the alkoxysilane, organoalkoxysilane, or metal alkoxide is defined,
wherein the alkoxysilane is a compound of the formula Si(OR)₄ the organoalkoxysilane is a compound of the formula R′ₓSi(OR)₄₋ₓ, and the metal alkoxide is a compound of the formula Me(OR)₄ where
each R is optionally substituted alkyl or aryl, and with particular preference methyl, ethyl, butyl, or propyl;
each R′ is halogen, in particular chlorine; optionally substituted alkyl, in particular methyl, ethyl, butyl, or propyl; or optionally substituted aryl;
x is a number from 1 to 4; and
Me is a transition metal or other metal, or semimetal, with particular preference Al, Ti, or Zr;
and/or wherein the alkoxysilane or organoalkoxysilane is selected from the group consisting of tetramethoxysilane, tetraethoxysilane, tetrapropoxysilane, methyl glycol orthosilicate, ethyl glycol orthosilicate, methyltrimethoxysilane, methyltriethoxysilane, dimethyldimethoxysilane, dimethyldiethoxysilane, ethyltrimethoxysilane, ethyltriethoxysilane, trimethylethoxysilane, 2-chloroethyltriethoxysilane, vinyltrimethoxysilane, vinyltriethoxysilane, vinylmethyldiethoxysilane, vinyltris(2-methyloxyethoxy)silane, phenyltrimethoxysilane, 2-phenylethyltrimethoxysilane, diphenyldimethoxysilane, propyltrimethoxysilane, propyltriethoxysilane, 3-chloropropyltrimethoxysilane, 3-chloropropyltriethoxysilane, propylmethyldimethoxysilane, propylmethyldiethoxysilane, 3-chloropropylmethyldimethoxysilane, 3-chloropropylmethyldiethoxysilane, isobutyltrimethoxysilane, isobutyltriethoxysilane, amyltrimethoxysilane, amyltriethoxysilane, octyltrimethoxysilane, octyltriethoxysilane, cyclohexyltrimethoxysilane, cyclohexylmethyldimethoxysilane, hexadecyltrimethoxysilane, and hexadecyltriethoxysilane, and combinations thereof;
and/or wherein the alkoxysilane/organoalkoxysilane has been functionalized with reactive groups suitable for crosslinking with the aminoplastic resin;
and/or wherein the reactive groups are selected from epoxy, methacrylic, glycidoxy, glycidoxypropyl, amine, hydroxy, carboxy, and vinyl, and mixtures thereof;
and/or the reaction mixture has any of the following additional features:
the reaction mixture comprises, as cosolvent for the alkoxysilane, organoalkoxysilane, or metal alkoxide, an organic solvent, in particular Dowanol, ethanol, or DMSO;
and/or the reaction mixture comprises, based on the total weight thereof, a quantity of from 12 to 16% by weight of formaldehyde, from 30 to 40% by weight of the component comprising amino, imino, or amide groups, and a quantity of from 5 to 15% by weight of the alkoxysilane, organoalkoxysilane, or metal alkoxide;
and/or the formaldehyde component and the component comprising amino, imino, or amide groups, both, present in the reaction mixture have been precondensed to a level of at least 20%, in particular at least 50%, before the at least one alkoxysilane, organoalkoxysilane, or metal alkoxide is added to the reaction mixture;
and/or the reaction of the reaction mixture takes place
on reaction of the reaction mixture at least 50 mol % of the at least one alkoxysilane, organoalkoxysilane, or metal alkoxide are condensed and/or hydrolyzed in the presence of formaldehyde and of the component comprising amino, imino, or amide groups;
and/or the reaction of the reaction mixture takes place at a pH of at least 9.0, and with particular preference at a pH of from 9.0 to 11.0;
and/or the reaction of the reaction mixture takes place in the temperature range from 20° C. to 90° C., preferably from 40° C. to 85° C., and particularly preferably from 60° C. to 80° C.;
and/or the component comprising amino, imino, or amide groups is selected from urea, melamine, thiourea, cyanamide, dicyandiamide, and diaminohexane, and mixtures thereof.

20. A process for the production of an aminoplastic resin for use as impregnation resin or liquid overlay, or for the surface-treatment of wood-derived materials, comprising at least the following step:
reaction of a reaction mixture which comprises formaldehyde, a component comprising amino, imino, or amide groups, and at least one alkoxysilane, organoalkoxysilane, or metal alkoxide at a pH of at least 8.0, preferably at least 9.0, and with particular preference at a pH of from 9.0 to 11.0.

21. The process as claimed in claim 20, wherein the alkoxysilane, organoalkoxysilane, or metal alkoxide is defined,
wherein the alkoxysilane is a compound of the formula Si(OR)₄, the organoalkoxysilane is a compound of the formula R′ₓSi(OR)₄₋ₓ, and the metal alkoxide is a compound of the formula Me(OR)₄ where
each R is optionally substituted alkyl or aryl, and with particular preference methyl, ethyl, butyl, or propyl;
each R′ is halogen, in particular chlorine; optionally substituted alkyl, in particular methyl, ethyl, butyl, or propyl; or optionally substituted aryl;
x is a number from 1 to 4; and
Me is a transition metal or other metal, or semimetal, with particular preference Al, Ti, or Zr;
and/or wherein the alkoxysilane or organoalkoxysilane is selected from the group consisting of tetramethoxysilane, tetraethoxysilane, tetrapropoxysilane, methyl glycol orthosilicate, ethyl glycol orthosilicate, methyltrimethoxysilane, methyltriethoxysilane, dimethyldimethoxysilane, dimethyldiethoxysilane, ethyltrimethoxysilane, ethyltriethoxysilane, trimethylethoxysilane, 2-chloroethyltriethoxysilane, vinyltrimethoxysilane, vinyltriethoxysilane, vinylmethyldiethoxysilane, vinyltris(2-methyloxyethoxy)silane, phenyltrimethoxysilane, 2-phenylethyltrimethoxysilane, diphenyldimethoxysilane, propyltrimethoxysilane, propyltriethoxysilane, 3-chloropropyltrimethoxysilane, 3-chloropropyltriethoxysilane, propylmethyldimethoxysilane, propylmethyldiethoxysilane, 3-chloropropylmethyldimethoxysilane, 3-chloropropylmethyldiethoxysilane, isobutyltrimethoxysilane, isobutyltriethoxysilane, amyltrimethoxysilane, amyltriethoxysilane, octyltrimethoxysilane, octyltriethoxysilane, cyclohexyltrimethoxysilane, cyclohexylmethyldimethoxysilane, hexadecyltrimethoxysilane, and hexadecyltriethoxysilane, and combinations thereof;
and/or wherein the alkoxysilane/organoalkoxysilane has been functionalized with reactive groups suitable for crosslinking with the aminoplastic resin;
and/or wherein the reactive groups are selected from epoxy, methacrylic, glycidoxy, glycidoxypropyl, amine, hydroxy, carboxy, and vinyl, and mixtures thereof;
and/or the reaction mixture has any of the following additional features:
the reaction mixture comprises, as cosolvent for the alkoxysilane, organoalkoxysilane, or metal alkoxide, an organic solvent, in particular Dowanol, ethanol, or DMSO;
and/or the reaction mixture comprises, based on the total weight thereof, a quantity of from 12 to 16% by weight of formaldehyde, from 30 to 40% by weight of the component comprising amino, imino, or amide groups, and a quantity of from 5 to 15% by weight of the alkoxysilane, organoalkoxysilane, or metal alkoxide;
and/or the formaldehyde component and the component comprising amino, imino, or amide groups, both, present in the reaction mixture have been precondensed to a level of at least 20%, in particular at least 50%, before the at least one alkoxysilane, organoalkoxysilane, or metal alkoxide is added to the reaction mixture;
and/or the reaction of the reaction mixture takes place
on reaction of the reaction mixture at least 50 mol % of the at least one alkoxysilane, organoalkoxysilane, or metal alkoxide are condensed and/or hydrolyzed in the presence of formaldehyde and of the component comprising amino, imino, or amide groups;
and/or the reaction of the reaction mixture takes place at a pH of at least 9.0, and with particular preference at a pH of from 9.0 to 11.0;
and/or the reaction of the reaction mixture takes place in the temperature range from 20° C. to 90° C., preferably from 40° C. to 85° C., and particularly preferably from 60° C. to 80° C.:
and/or the component comprising amino, imino, or amide groups is selected from urea, melamine, thiourea, cyanamide, dicyandiamide, and diaminohexane, and mixtures thereof.

22. An aminoplastic resin for use as impregnation resin or liquid overlay in the production of impregnated material or of laminate, or the surface-treatment of wood-derived materials obtainable by a process as in claim 20.
